(19) United States
(12) Patent Application Publication
(10) Pub. No.: US 2010/0033634 A1
(43) Pub. Date: Feb. 11, 2010

(54) DISPLAY DEVICE

(75) Inventors: Yun-Jae KIM, Asan-si (KR); Bong-Im PARK, Cheonan-si (KR); Bong-Ju JUN, Cheonan-si (KR); Jae-Won JEONG, Seoul (KR); Yong-Jun CHOI, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, Gyeonggi-do (KR)

(21) Appl. No.: 12/507,215

(22) Filed: Jul. 22, 2009

(30) Foreign Application Priority Data
Aug. 5, 2008 (KR) 10-2008-0076546

(51) Int. Cl. H04N 5/14; G09G 3/00; G06K 9/36

(52) U.S. Cl. 348/699; 345/30; 348/E05.062; 382/236

(57) ABSTRACT

A display device includes; an image signal processing unit which extracts a motion vector of an (n−1)-th frame by comparing two consecutive (n−2)-th and (n−1)-th frames of a first image signal, generates an interpolated frame using the motion vector of the (n−1)-th frame, and generates a second image signal including the interpolated frame, the interpolated frame being inserted between the (n−1)-th frame and the n-th frame, wherein n is a natural number, and a display panel which displays an image corresponding to the second image signal.

This application claims priority to Korean Patent Application No. 10-2008-0076546, filed on Aug. 5, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display device, and more particularly, to a display device which can improve the speed of processing an image signal and can reduce the manufacturing cost of the display device.

2. Description of the Related Art

Recently, techniques of improving the display quality of a display device by inserting interpolated frames obtained by compensating for the motion of an object between original frames have been developed. In these techniques, a display device may display an image having a total of 120 frames per second based on image information regarding only 60 frames per second. For this, the display device may include an image signal processing unit capable of generating an interpolated frame, which can be inserted between two consecutive original frames.

The image signal processing unit may extract a motion vector by comparing two consecutive frames, e.g., (n−1)-th and n-th frames, and may generate an interpolated frame based on the motion vector. The generation of an interpolated frame may reduce the overall speed of image processing and increase the manufacturing cost of a display device.

### BRIEF SUMMARY OF THE INVENTION

Aspects of the present invention provide a display device which can improve the speed of processing an image signal and can reduce the manufacturing cost thereof.

The aspects, features and advantages of the present invention are not restricted to the ones set forth herein. The above and other aspects, features and advantages of the present invention will become more apparent to one of ordinary skill in the art to which the present invention pertains by referencing a detailed description of the present invention given below.

According to an exemplary embodiment of the present invention a display device includes; an image signal processing unit which extracts a motion vector of an (n−1)-th frame by comparing two consecutive (n−2)-th and (n−1)-th frames of a first image signal, generates an interpolated frame using the motion vector of the (n−1)-th frame, and generates a second image signal including the interpolated frame, the interpolated frame being inserted between the (n−1)-th frame and an n-th frame, wherein n is a natural number, and a display panel which displays an image corresponding to the second image signal.

According to another exemplary embodiment of the present invention a display device includes; an image signal processing unit which generates a second image signal by inserting an interpolated frame between two consecutive (n−2)-th and (n−1)-th frames of a first image signal and outputs the second image signal, and a display panel which displays an image corresponding to the second image signal, wherein the image signal processing unit includes; a motion estimator which extracts a motion vector of the (n−1)-th frame by comparing the (n−1)-th frame and the n-th frame and acquires laminar flow region data regarding a laminar flow region, from which a number of laminar flow motion vectors having a substantially uniform magnitude in a substantially uniform direction are extracted, a motion vector offset unit which calculates an offset motion vector by offsetting the motion vector of the (n−1)-th frame, and a motion interpolator which generates the interpolated frame using the laminar flow region data and the offset motion vector.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates a block diagram of an exemplary embodiment of a display device according to the present invention;

FIG. 2 illustrates an equivalent circuit diagram of an exemplary embodiment of a pixel of an exemplary embodiment of a display device shown in FIG. 1;

FIG. 3 illustrates a block diagram of an exemplary embodiment of a signal control module shown in FIG. 1;

FIG. 4 illustrates a block diagram of an exemplary embodiment of an image signal processing unit shown in FIG. 3;

FIG. 5 illustrates a block diagram of exemplary embodiments of a motion estimator and a motion compensator shown in FIG. 4;

FIG. 6A illustrates a diagram illustrating the calculation of a motion vector by an exemplary embodiment of a motion vector extractor shown in FIG. 5;

FIG. 6B is a magnified view of the area “B” in FIG. 6A; and

FIGS. 7A through 7C illustrate diagrams illustrating the generation of an interpolated frame by the exemplary embodiment of an image signal processing unit shown in FIG. 3.

### DETAILED DESCRIPTION OF THE INVENTION

The invention now will be described more fully hereinafter with reference to the accompanying drawings, in which exemplary embodiments of the invention are shown. This invention may be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, when the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

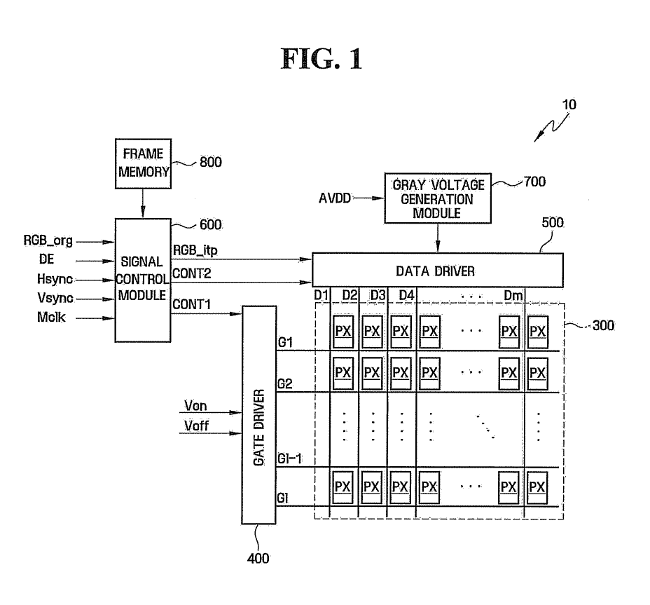

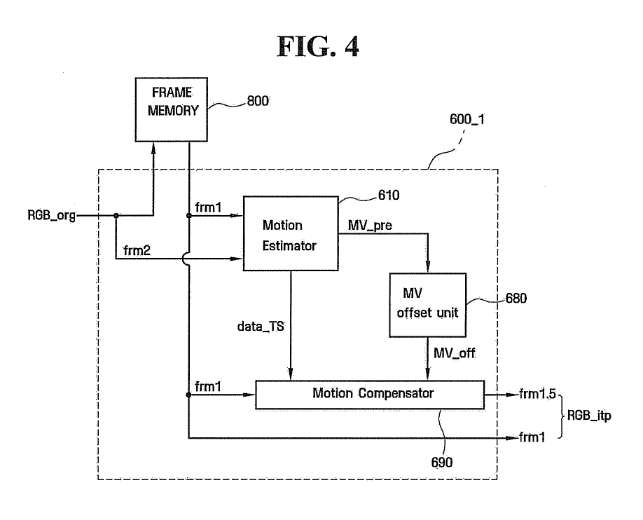

An exemplary embodiment of a display device according to the present invention will hereinafter be described in detail with reference to FIGS. 1 through 7C. In FIGS. 3 through 7C, reference character frm1 indicates an (n−1)-th frame (where n is a natural number), reference character frm2 indicates an n-th frame and reference character frm1.5 indicates an interpolated frame inserted between the (n−1)-th frame and the n-th frame.

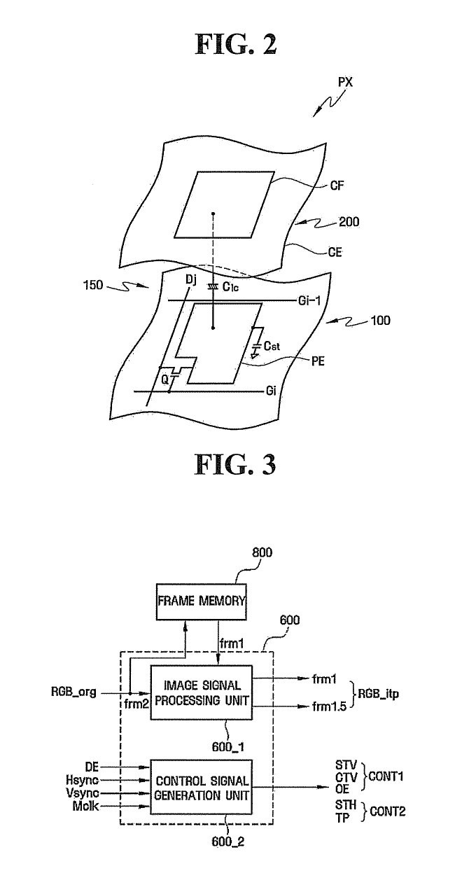

FIG. 1 illustrates a block diagram of an exemplary embodiment of a display device 10, one exemplary embodiment of which includes a liquid crystal display device (“LCD”), according to the present invention, and FIG. 2 illustrates an equivalent circuit diagram of an exemplary embodiment of a pixel PX of an exemplary embodiment of a display panel 300 shown in FIG. 1.

Referring to FIG. 1, the display device 10 may include the display panel 300, a signal control module 600, a frame memory 800, a gate driver 400, a data driver 500, and a gray voltage generation module 700.

The display panel 300 includes a plurality of gate lines G1 through Gl, a plurality of data lines D1 through Dm and a plurality of pixels PX. The gate lines G1 through Gl extend in a column direction substantially in parallel with one another, and the data lines D1 through Dm extend in a row direction substantially in parallel with one another and substantially perpendicular to the gate lines G1 through Gl. The pixels PX are disposed at the areas where the gate lines G1 through Gl and the data lines D1 through Dm overlap one another. A gate signal may be applied to each of the gate lines G1 through Gl by the gate driver 400, and an image data voltage may be applied to each of the data lines D1 through Dm by the data driver 500. Each of the pixels PX displays an image in response to the image data voltage. For example, in the exemplary embodiment wherein the display panel 300 is an LCD, each of the pixels PX may vary its transmittance level according to the image data voltage.

The signal control module 600 may output a second image signal RGB_itp to the data driver 500. The data driver 500 may output an image data voltage corresponding to the second image signal RGB_itp. Each of the pixels PX displays an image in response to a corresponding image data voltage, and thus is able to display an image corresponding to the second image signal RGB_itp.

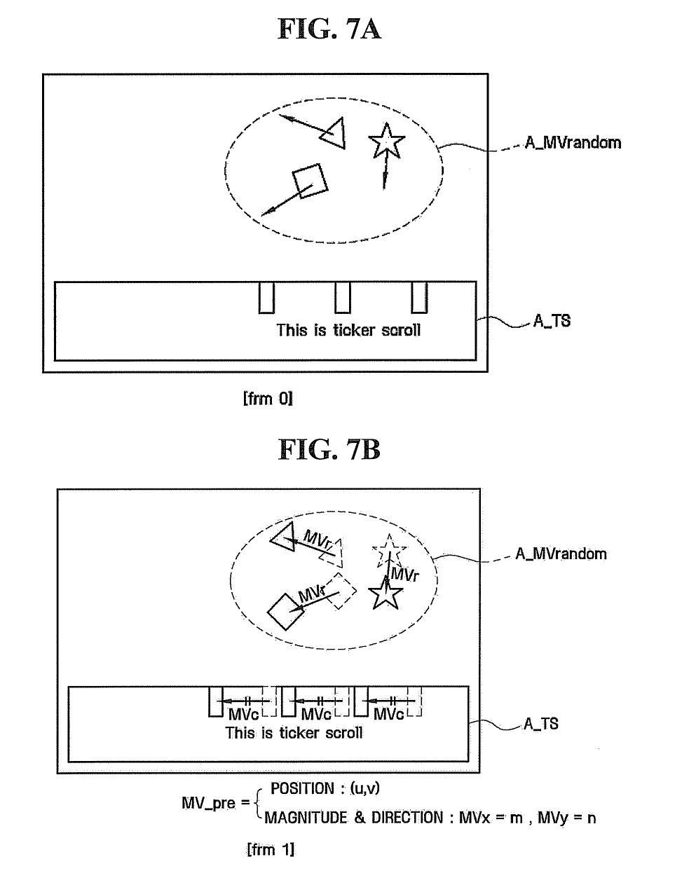

The display panel 300 may include a plurality of display blocks DB, each display block including a number of pixels PX arranged in a matrix, as will be described later in further detail with reference to FIG. 6.

Referring to FIG. 2, a pixel PX, which is connected to an i-th gate line Gi (1≦i≦l) and a j-th data line Dj (1≦j≦m), includes a switching element Q, which is connected to the i-th gate line Gi and the j-th data line Dj, and a liquid crystal capacitor C_{1c} and a storage capacitor Cₛₜ, which are both connected to the switching element Q. The liquid crystal capacitor C_{1c} includes a pixel electrode PE, which is formed on the first display panel 100, a common electrode CE, which is formed on the second display panel 200, and liquid crystal molecules 150, which are interposed between the pixel electrode PE and the common electrode CE. In the present exemplary embodiment, a color filter CF is disposed on the common electrode CE, although alternative exemplary embodiments may include configurations wherein the color filter CF is disposed on the first display panel 100.

Referring back to FIG. 1, the signal control module 600 receives a first image signal RGB_org and a plurality of external control signals DE, Hsync, Vsync and Mclk for controlling the display of the first image signal RGB_org, and may output the second image signal RGB_itp, a gate control signal CONT1 and a data control signal CONT2. The second image signal RGB_itp is an image signal obtained by inserting an interpolated frame between two consecutive (n−1)-th and n-th frames of the first image signal RGB_org. For example, the first image signal RGB_org may have a frequency of 60 Hz, and the second image signal RGB_itp may have a frequency of 120 Hz.

The signal control module 600 may receive the first image signal RGB_org, and may output the second image signal RGB_itp. In addition, the signal control module 600 may receive the external control signals Vsync, Hsync, Mclk and DE from an external source, and may generate the gate control signal CONT1 and the data control signal CONT2. In one exemplary embodiment, the external control signals Vsync, Hsync, Mclk and DE include a vertical synchronization signal Vsync, a horizontal synchronization signal Hsync, a main clock signal Mclk, and a data enable signal DE. The gate control signal CONT1 is a signal for controlling the operation of the gate driver 400, and the data control signal CONT2 is a signal for controlling the operation of the data driving unit 500. The signal control module 600 will be described later in further detail with reference to FIG. 3.

The frame memory 800 may store image information regarding each frame of the first image signal RGB_org. The signal control module 600 may read out image information regarding an (n−1)-th frame frm1 from the frame memory 800, may generate an interpolated frame based on the read-out image information, and may generate the second image signal RGB_itp using the interpolated frame.

The gate driver 400 is provided with the gate control signal CONT1 by the signal control module 600, and applies a gate signal to the gate lines G1 through Gl. The gate signal may include a combination of a gate-on voltage Von and a gate-off voltage Voff, which are provided by a gate-on/off voltage generation module (not shown).

The data driver 500 is provided with the data control signal CONT2 by the signal control module 600, and applies an image data voltage corresponding to the second image signal RGB_itp to the data lines D1 through Dm. The image data voltage corresponding to the second image signal RGB_itp may be provided by the gray voltage generation module 700.

In one exemplary embodiment, the gray voltage generation module 700 may generate an image data voltage by dividing a driving voltage AVDD according to the grayscale level of the second image signal RGB_itp, and may provide the generated image data voltage to the data driver 500. The gray voltage generation module 700 may include a plurality of resistors which are connected in series between a ground and a node, to which the driving voltage AVDD is applied, and may thus generate a plurality of gray voltages by dividing the driving voltage AVDD. The structure of the gray voltage generation module 700 is not restricted to this exemplary embodiment. That is, the gray voltage generation module 700 may be realized in various manners, other than that set forth herein.

FIG. 3 illustrates a block diagram of an exemplary embodiment of the signal control module 600. Referring to FIG. 3, the signal control module 600 may include an image signal processing unit 600_1 and a control signal generation unit 600_2.

In order to improve the display quality of the display device 10, the image signal processing unit 600_1 may insert a number of interpolated frames among original frames, and may output the interpolated and original frames.

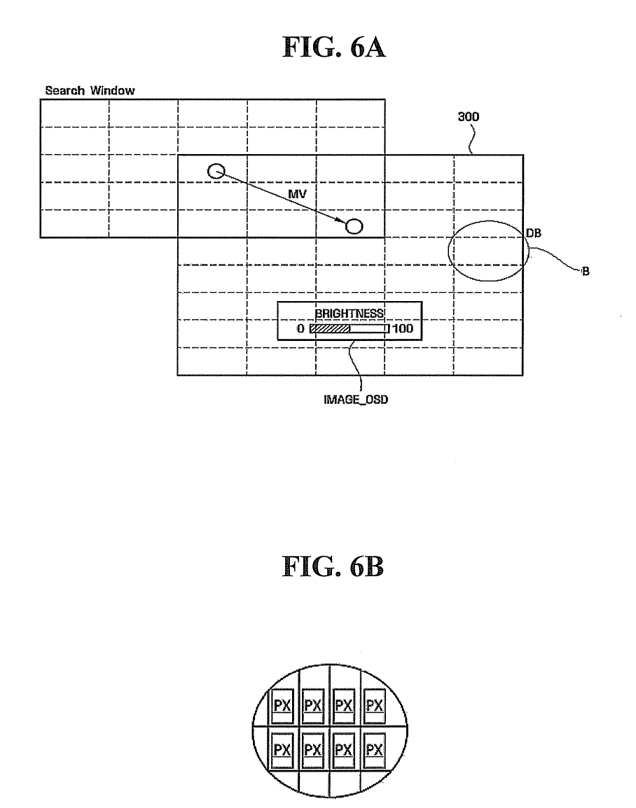

The image signal processing unit 600_1 may receive the first image signal RGB_org and may provide the second image signal RGB_itp including the (n−1)-th frame frm1 and an interpolated frame frm1.5. The image signal processing unit 600_1 may generate the second image signal RGB_itp by inserting the interpolated frame frm1.5 between two consecutive frames of the first image signal RGB_org, e.g., between the (n−1)-th frame frm1 and an n-th frame frm2. The image signal processing unit 600_1 may read out image information regarding the (n−1)-th frame frm1 from the frame memory 800, and may generate the interpolated frame frm1.5 based on the read-out image information, as illustrated in FIG. 5.

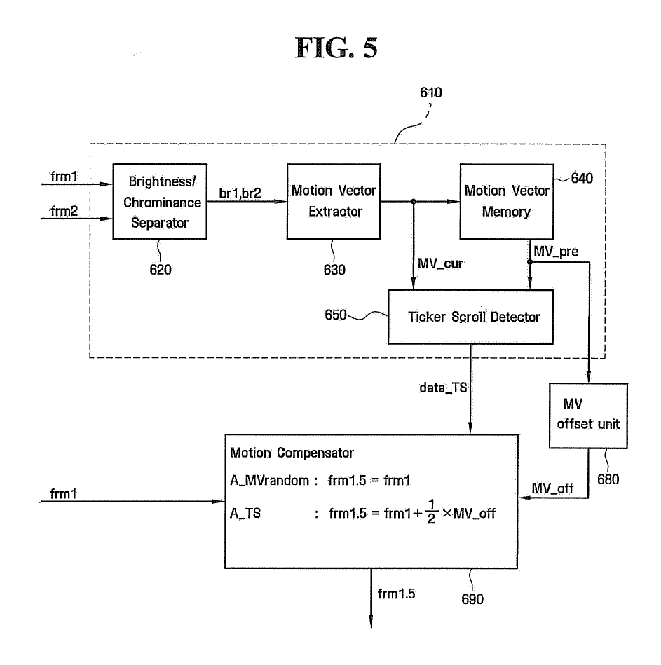

The structure and the operation of the image signal processing unit 600_1 will be described later in further detail with reference to FIGS. 4 and 5.

The control signal generation unit 600_2 may receive the external control signals DE, Hsync, Vsync, and Mclk and may generate the data control signal CONT2 and the gate control signal CONT1. The gate control signal CONT1 is a signal for controlling the operation of the gate driver 400. The gate control signal CONT1 may include a vertical initiation signal STV for initiating the operation of the gate driver 400, a gate clock signal CTV for determining when to output the gate-on voltage Von, and an output enable signal OE for determining the pulse width of the gate-on voltage Von. The data control signal CONT2 may include a horizontal initiation signal STH for initiating the operation of the data driver 500 and an output instruction signal TP for providing instructions to output an image data voltage.

FIG. 4 illustrates a block diagram of the image signal processing unit 600_1 shown in FIG. 3. Referring to FIG. 4, the image signal processing unit 600_1 may extract a motion vector MV_pre of the (n−1)-th frame frm1 by comparing two consecutive frames of the first image signal RGB_org, e.g., the (n−1)-th frame frm1 and the n-th frame frm2, and may generate the interpolated frame frm1.5 based on the motion vector MV_pre of the (n−1)-th frame frm1. The image signal processing unit 600_1 may generate the interpolated frame frm1.5 using an offset motion vector MV_off, instead of using the motion vector MV_pre. The offset motion vector MV_off is a motion vector obtained by offsetting the motion vector MV_pre.

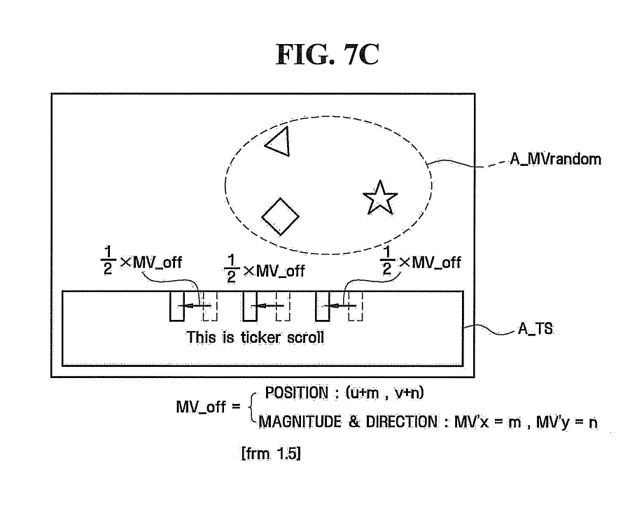

The image signal processing unit 600_1 may divide an image displayed on the display panel 300 shown in FIG. 1 into a first region and a second region, and may generate an interpolated frame by applying different methods to the first and second regions of the image. An image displayed on the display panel 300 may include a region in which the magnitude and the direction of motion vectors are uniformly maintained for a predefined amount of time. For example, referring to FIGS. 7A through 7C, a ticker scroll A_TS is displayed on a lower part of the display panel 300 as flowing along one direction, and a number of motion vectors having a uniform magnitude in a uniform direction (e.g., a horizontal direction) for a predetermined amount of time may be extracted from a portion of an image including the ticker scroll A_TS. The image signal processing unit 600_1 may generate an interpolated frame by classifying the image portion including the ticker scroll A_TS as a second region and classifying the remaining portion, excluding the second region, as a first region. A second region may also be referred to as a laminar flow region, and motion vectors extracted from a second region may be referred to as second motion vectors or laminar flow motion vectors. A second region and a laminar flow motion vector will be described later in detail with reference to FIG. 5.

Referring to FIG. 4, the image signal processing unit 600_1 may include a motion estimator 610, a motion vector offset unit 680, and a motion compensator 690.

The motion estimator 610 extracts a motion vector MV_cur (not shown) by comparing the n-th frame frm2 and the (n−1)-th frame frm1. The motion estimator 610 may acquire second region data data_TS regarding the second region in which the magnitude and the direction of motion vectors are uniformly maintained for a predetermined amount of time. The motion estimator 610 may compare the n-th frame frm2 with the (n−1)-th frame frm1, which is read out from the frame memory 800, may extract the motion vector MV_cur, and may provide a motion vector MV_pre to the motion vector offset unit 680. The motion estimator 610 may provide the second region data data_TS to the motion compensator 690. Extracting the motion vector MV_cur and providing the motion vector MV_pre will be described later in detail with reference to FIG. 5.

The motion vector offset unit 680 may obtain an offset motion vector MV_off by offsetting the motion vector MV_pre. The motion vector offset unit 680 may be provided with the motion vector MV_pre by the motion estimator 610, may calculate the offset motion vector MV_off based on the motion vector MV_pre, and may provide the offset motion vector MV_off to the motion compensator 690. The offset motion vector MV_off will be described later in further detail with reference to FIG. 7C.

The motion compensator 690 may generate the interpolated frame frm1.5 using the second region information data_TS and the offset motion vector MV_off. The motion compensator 690 receives the read out (n−1)-th frame frm1 from the frame memory 800, may be provided with the second region data data_TS by the motion estimator 610, and may be provided with the offset motion vector MV_off by the motion vector offset unit 680. Thereafter, the motion compensator 690 may generate the interpolated frame frm1.5 using the (n−1)-th frame, the second region data data_TS and the offset motion vector MV_off, and may output the interpolated frame frm1.5.

The motion estimator 610 and the motion compensator 690 will hereinafter be described in further detail with reference to FIG. 5.

FIG. 5 illustrates a block diagram of the motion estimator 610 and the motion compensator 690 shown in FIG. 4. Referring to FIG. 5, the motion estimator 610 may include a brightness/chrominance separator 620, a motion vector extractor 630, a motion vector memory 640 and a ticker scroll detector 650.

The brightness/chrominance separator 620 separates a brightness component br1 and a chrominance component (not shown) from the (n−1)-th frame frm1 and separates a brightness component br2 and a chrominance component (not shown) from the n-th frame frm2. In the present exemplary embodiment, a brightness component of an image signal has information regarding the brightness of the image signal. In the present exemplary embodiment, a chrominance component of an image signal has information regarding the color(s) of the image signal.

The motion vector extractor 630 calculates a motion vector MV_cur of the n-th frame by comparing the (n−1)-th frame frm1 and the n-th frame frm2. In one exemplary embodiment, the motion vector extractor 630 may calculate the motion vector MV_cur using the brightness components br1 and br2. The motion vector extractor 630 calculates a motion vector MV_pre of the (n−1)-th frame by comparing the (n−2)-th frame (not shown) and the (n−1)-th frame frm1. In one exemplary embodiment, the motion vector extractor 630 may calculate the motion vector MV_pre using the brightness components br0 and br1, wherein a brightness component br0 is separated from the (n−2)-th frame.

A motion vector is a mathematical representation indicating the motion of an object in an image. The motion vector extractor 630 may analyze the brightness components br1 and br2, and may determine that a predetermined object is located in portions of the (n−1)-th frame frm1 and the n-th frame frm2 having almost the same brightness distribution pattern. Then, the motion vector extractor 630 may extract the motion vector MV_cur based on the motion of the predetermined object between the (n−1)-th frame frm1 and the n-th frame frm2. The extraction of a motion vector will be described later in further detail with reference to FIG. 6.

The motion vector memory 640 may store the motion vector MV_cur provided by the motion vector extractor 630. A motion vector MV_pre of the (n−1)-th frame is calculated by comparing the (n−2)-th frame and the (n−1)-th frame by the motion vector extractor 630, similarly to the calculation of the motion vector MV_cur of the n-th frame calculated by comparing the (n−1)-th frame and the n-th frame. The ticker scroll detector 650 and the motion vector offset unit 680 may receive a read out motion vector MV_pre of the (n−1)-th frame frm1 from the motion vector memory 640.

The ticker scroll detector 650 may be provided with the motion vector MV_cur by the motion vector extractor 630, may receive the read out motion vector MV_pre from the motion vector memory 640, and may acquire the second region information data_TS by comparing the motion vector MV_cur and the motion vector MV_pre.

As described above, an image displayed on the display panel 300 may include a region in which the magnitude and the direction of motion vectors are uniformly maintained for a predefined amount of time. For example, referring to FIGS. 7A through 7C, the ticker scroll A_TS is displayed on a lower part of the display panel 300 as flowing along one direction, and a number of motion vectors having a substantially uniform magnitude in a substantially uniform direction (e.g., a horizontal direction) for a predetermined amount of time may be extracted from a portion of an image including the ticker scroll A_TS. Therefore, it is possible to determine a portion of an image in which the magnitude and the direction of motion vectors are uniformly maintained for a predetermined amount of time as a second region by comparing the motion vector MV_cur and the motion vector MV_pre.

The motion compensator 690 may generate the interpolated frame frm1.5 using the offset motion vector MV_off provided by the motion vector offset unit 680, and may output the interpolated frame frm1.5.

The motion compensator 690 may generate the interpolated frame frm1.5 by applying image data of the (n−1)-th frame frm1 for a first region of an image and applying the offset motion vector MV_off for a second region of the image. As described above, the second region, like a region in an image in which a ticker scroll is displayed, may be a region in which the magnitude and the direction of motion vectors are uniformly maintained for a predetermined amount of time, and the first region may be a whole image except for a second region. Given this, a first region may be defined as a region from which a number of random motion vectors having random directions and random magnitudes are extracted. Referring to FIG. 5, reference character A_MVrandom corresponds to the first region, and reference character A_TS corresponds to the second region.

The motion compensator 690 may apply the image data of the (n−1)-th frame frm1 as it is to the first region A_MVramdom of the interpolated frame frm1.5, and may compensate for the motion of an object to be displayed in the second region A_TS of the interpolated frame frm1.5 by using the offset motion vector MV_off. The motion compensator 690 may compensate for the motion of the object to be displayed in the second region A_TS of the interpolated frame frm1.5 by using an offset motion vector MV_off obtained by applying a weight of ½ to the motion vector of the (n−1)-th frame frm1. The operation of the motion compensator 690 will be described later in further detail with reference to FIGS. 7A through 7C.

FIG. 6A is a diagram illustrating the calculation of a motion vector by the motion vector extractor 630 shown in FIG. 5, and FIG. 6B is a magnified view of the area “B” in FIG. 6A. Referring to FIGS. 6A and B, the display panel 300 may include a plurality of display blocks DB, and each display block DB may include a plurality of pixels PX arranged substantially in a matrix shape. That is, the display panel 300 is divided into the display blocks DB, each display block DBM including a plurality of pixels PX, as indicated by dotted lines.

The motion vector extractor 630 may detect the same object from the (n−1)-th frame frm1 and the n-th frame frm2 by comparing an image signal corresponding to the (n−1)-th frame frm1 and an image signal corresponding to the n-th frame frm2. In the present exemplary embodiment, the motion vector extractor 630 may detect the same object from the (n−1)-th frame frm1 and the n-th frame frm2 by using a sum-of-absolute differences (“SAD”) method. In the SAD method, a display block DB of a previous frame producing a smallest sum of absolute luminance differences with each display block DB of a current frame is determined to be the best matching block for a corresponding display block DB of the current frame. The SAD method is well-known to one of ordinary skill in the art, to which the present invention pertains, and thus, a detailed description of the SAD method will be omitted.

Alternative exemplary embodiments may utilize alternative methods of detecting the same object from the (n−1)-th frame frm1 and the n-th frame frm2. In one alternative exemplary embodiment, the motion vector extractor 630 may detect the same object from the (n−1)-th frame frm1 and the n-th frame frm2 using a search window. That is, the motion vector extractor 630 may detect the same object from the (n−1)-th frame frm1 and the n-th frame frm2 by searching through only a number of display blocks DB within the search window.

Referring to FIG. 6A, a circular object and an on-screen display (“OSD”) image IMAGE_OSD are detected from both the (n−1)-th frame frm1 and the n-th frame frm2. The motion vector MV is the motion vector of the circular object and is indicated by an arrow. The OSD image IMAGE_OSD may be an example of a still object or still text. A still object or still text has a motion vector of 0. The OSD image IMAGE_OSD is well-known to one of ordinary skill in the art, to which the present invention pertains, and thus, a detailed description of the OSD image IMAGE_OSD will be omitted.

FIGS. 7A through 7C are diagrams illustrating the generation of an interpolated frame by the image signal processing unit 600_1 shown in FIG. 3.

Referring to FIGS. 7A and 7B, an image displayed on the display panel 300 shown in FIG. 1 may be divided into a first region A_MVrandom from which a plurality of random first motion vectors MVr are extracted and a second region A_TS from which a plurality of second motion vectors MVc having a uniform magnitude in a uniform direction are extracted. As shown in FIGS. 7A-7C, in the present exemplary embodiment wherein the second region corresponds to a ticker scroll, the second motion vectors MVc may have a uniform magnitude in a horizontal direction. The second region A_TS may be a region in which a ticker scroll is displayed.

The motion vector MV_pre of the (n−1)-th frame may be calculated by comparing an (n−2)-th frame frm0 and the (n−1)-th frame frm1. Referring to FIGS. 7A and 7B, a plurality of objects displayed in a second region A_TS may be shifted horizontally by the magnitude of the second motion vectors MVc. Assuming that the display panel 300 is laid out in a manner corresponding to an XY coordinate plane, the position of the motion vector MV_pre may be represented as (u, v), and the magnitude and the direction of the motion vector MV_pre may be represented as (m, n). The point of application of the motion vector MV_pre may be represented as (u, v), and x- and y-axis components MVx and MVy of the motion vector MV_pre may be represented as m and n, respectively. The second motion vectors MVc, which are extracted from the second region A_TS, may have substantially the same magnitude and direction, and may have different positions or points of application.

Referring to FIG. 7C, the same image as that displayed in a first region A_MVrandom of the (n−1)-th frame frm1 may be displayed in a first region A_MVrandom of the interpolated frame frm1.5. An image obtained by compensating for the motion of the objects displayed in the second region A_TS of the (n−1)-th frame frm1 may be displayed in a second region A_TS of the interpolated frame frm1.5. The motion of the objects displayed in the second region A_TS of the (n−1)-th frame frm1 may be compensated for by applying a weight of ½ to the offset motion vector MV_off, which is obtained by offsetting the motion vector MV_pre.

In this exemplary embodiment, the motion of an object may be compensated for by using a motion vector of a previous frame, instead of using a motion vector of a current frame. An offset motion vector obtained by offsetting the motion vector of the previous frame may be treated as the motion vector of the current frame for the following reasons.

A second region A_TS is a region from which a plurality of second motion vectors MVc having a uniform magnitude in a uniform direction for a predetermined amount of time are extracted. Accordingly, the magnitude and the direction of a motion vector in the second region A_TS of a previous frame may be substantially the same as the magnitude and the direction of a motion vector in the second region A_TS of a current frame. Thus, it is safe to assume that an offset motion vector obtained by offsetting the motion vector of the previous frame has substantially the same magnitude and direction as the motion vector of the current frame.

The point of application (or the position) of the motion vector of a previous frame and the point of application (or the position) of the motion vector of a current frame may not match, e.g., the object to which the motion vector is to be applied may have moved from the previous frame to the current frame. The mismatch between the point of application of the motion vector of the previous frame and the point of application of the motion vector of the current frame may be appropriately offset. For example, when the position of the motion vector of the previous frame is (u, v), and the magnitude of the motion vector of the previous frame is (m, n), the position of an offset motion vector obtained by offsetting the motion vector of the previous frame may be represented as (u+m, v+n).

A second region A_TS is a region from which a number of second motion vectors MVc having a uniform magnitude in a uniform direction for a predetermined amount of time are extracted. When the magnitude and the direction of the second motion vectors MVc are described in Cartesian coordinates as (m, n), the position of the motion vector of a current frame may be obtained by shifting the position of the motion vector of a previous frame by m along the X-axis and n along the Y-axis. As a result, the position of the motion vector of the current frame may coincide with the position (e.g., (u+m, v+n)) of an offset motion vector obtained by offsetting the motion vector of the previous frame.

As described above with reference to FIGS. 7A through 7C, in the present exemplary embodiment, the motion of an object in a first region A_MVrandom from which a number of random first motion vectors MVr are extracted is not compensated for. It is generally hard for a viewer to keep a constant eye on the motion of every object in the first region A_MVrandom. Therefore, even if the motion of each object in the first region A_MV is not compensated for, the viewer may not be able to detect any display quality deterioration from the first region A_MVrandom. The viewer may be able to easily detect display quality deterioration from a second region A_TS, from which a number of second motion vectors MVc having a substantially uniform magnitude in a substantially uniform direction are extracted. For example, when the second region A_TS is a region in which a ticker scroll is displayed, the viewer may be able to easily detect a display quality deterioration from the second region A_TS because tickers are generally displayed as flowing along one direction. In this exemplary embodiment, the motion of an object in the second region A_TS is compensated for, thereby improving the display quality.

As described above, according to the present invention, an image signal processing unit can generate an interpolated frame using a motion vector of a previous frame without the need to use a motion vector of a current frame. Therefore, it is possible to reduce the time taken to generate an interpolated frame by as much time as it usually takes the image signal processing unit to acquire the motion vector of the current frame. In addition, it is possible to quickly output the interpolated frame and thus to improve the speed of processing an image signal.

In general, in order to generate an interpolated frame using a motion vector of a current frame, it is necessary to extract the motion vector of the current frame and to delay output of a previous frame until the motion vector of the current frame is extracted. According to the present invention, it is possible to generate an interpolated frame by simply using the motion vector of the previous frame without the need to use the motion vector of the current frame. Therefore, it is possible to perform the extraction of a motion vector and the generation of an interpolated frame substantially at the same time. In addition, it is possible to reduce the storage capacity required for delaying the output of the previous frame and thus to reduce the manufacturing cost of a display device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device comprising:
an image signal processing unit which extracts a motion vector of an (n−1)-th frame by comparing two consecutive (n−2)-th and (n−1)-th frames of a first image signal, generates an interpolated frame using the motion vector of the (n−1)-th frame, and generates a second image signal including the interpolated frame, the interpolated frame being inserted between the (n−1)-th frame and an n-th frame, wherein n is a natural number; and
a display panel which displays an image corresponding to the second image signal.

2. The display device of claim 1, wherein the image signal processing unit starts generation of the interpolated frame of the (n−1)-th frame prior to extraction of the motion vector of the n-th frame.

3. The display device of claim 1, wherein the image signal processing unit uses a motion vector other than that corresponding to the n-th frame to generate the interpolated frame.

4. The display device of claim 1, wherein the image signal processing unit generates the interpolated frame using an offset motion vector obtained by offsetting a motion vector of the (n−1)-th frame.

5. The display device of claim 4, wherein, when the magnitude and the direction of the motion vector of the (n−1)-th frame are described in Cartesian coordinates as (m, n) and the position of the motion vector of the (n−1)-th frame is described in Cartesian coordinates as (u, v), the magnitude and the direction of the offset motion vector are (m, n) and the position of the offset motion vector is (u+m, v+n).

6. The display device of claim 1, wherein the image signal processing unit comprises a motion vector memory which stores the motion vector of the (n−1)-th frame.

7. The display device of claim 1, wherein the image signal processing unit generates the interpolated frame by applying image data of the (n−1)-th frame to a first region from which a number of random first motion vectors are extracted, and applying the motion vector of the (n−1)-th frame to image data corresponding to a second region from which a number of second motion vectors having a substantially uniform magnitude in a substantially uniform direction are extracted.

8. The display device of claim 7, wherein the second motion vectors have a substantially uniform magnitude in a horizontal direction, and the magnitude and the direction of the second motion vectors are substantially uniformly maintained in the second region for a predetermined amount of time.

9. The display device of claim 7, wherein the second region is a region in which a ticker scroll is displayed.

10. The display device of claim 1, wherein the image signal processing unit comprises:
a motion estimator which extracts the motion vector of the (n−1)-th frame and acquires second region data regarding a second region, from which a number of second motion vectors having a substantially uniform magnitude in a substantially uniform direction are extracted;
a motion vector offset unit which calculates an offset motion vector by offsetting the motion vector of the (n−1)-th frame; and
a motion compensator which generates the interpolated frame using the second region data and the offset motion vector.

11. The display device of claim 10, wherein:
the image signal processing unit further comprises a motion vector memory, which stores the motion vector of the (n−1)-th frame; and
the motion vector offset unit reads out the motion vector of the (n−1)-th frame from the motion vector memory.

12. A display device comprising:
an image signal processing unit which generates a second image signal by inserting an interpolated frame between two consecutive (n−1)-th and n-th frames of a first image signal and outputs the second image signal, wherein n is a natural number; and
a display panel which displays an image corresponding to the second image signal,
wherein the image signal processing unit comprises:
a motion estimator which extracts a motion vector of the (n−1)-th frame by comparing the (n−2)-th frame and the (n−1)-th frame and acquires laminar flow region data regarding a laminar flow region, from which a number of laminar flow motion vectors having a substantially uniform magnitude in a substantially uniform direction are extracted:
a motion vector offset unit which calculates an offset motion vector by offsetting the motion vector of the (n−1)-th frame; and
a motion interpolator which generates the interpolated frame using the laminar flow region data and the offset motion vector.

13. The display device of claim 12, wherein the image signal processing unit starts generation of the interpolated frame of the (n−1)-th frame prior to extraction of the motion vector of the n-th frame.

14. The display device of claim 12, wherein the image signal processing unit uses a motion vector other than that of the n-th frame to generate the interpolated frame.

15. The display device of claim 12, wherein, when the magnitude and the direction of the motion vector of the (n−1)-th frame are described in Cartesian coordinates as (m, n) and the position of the motion vector of the (n−1)-th frame is described in Cartesian coordinates as (u, v), the magnitude and the direction of the offset motion vector are (m, n) and the position of the offset motion vector is (u+m, v+n).

16. The display device of claim 12, wherein the image signal processing unit generates the interpolated frame by applying image data of the (n−1)-th frame to a region from which a number of random motion vectors are extracted.

17. The display device of claim 12, wherein the laminar flow motion vectors have a substantially uniform magnitude in a horizontal direction, and the magnitude and the direction of the laminar flow motion vectors are substantially uniformly maintained in the laminar flow region for a predetermined amount of time.

18. The display device of claim 12, wherein the laminar flow region is a region in which a ticker scroll is displayed.

19. The display device of claim 12, wherein the image signal processing unit further comprises:
a motion vector memory which stores the motion vector of the (n−1)-th frame; and
the motion vector offset unit reads out the motion vector of the (n−1)-th frame from the motion vector memory.

20. A method of driving a display device, the method comprising:
extracting a motion vector of an (n−1)-th frame by comparing two consecutive (n−2)-th and (n−1)-th frames of a first image signal, wherein n is a natural number;
generating an interpolated frame using the motion vector of the (n−1)-th frame;
generating a second image signal including the interpolated frame, the interpolated frame being inserted between the (n−1)-th frame and the n-th frame; and
displaying an image corresponding to the second image signal.
